(19) United States
(12) Patent Application Publication
(10) Pub. No.: US 2003/0222850 A1
(43) Pub. Date: Dec. 4, 2003

(54) Flat panel display apparatus

(76) Inventor: Yuan-Hsing Hung, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/223,457

(22) Filed: Aug. 19, 2002

(30) Foreign Application Priority Data
Jun. 4, 2002 (TW) 091208239

(51) Int. Cl. G09G 5/00

(52) U.S. Cl. 345/156

(57) ABSTRACT

A flat panel display apparatus is disclosed. A printed circuit board is secured onto a removable frame, and the inner case is mounted onto the back side of the side bracket binding the inner case and the display panel together. The outer case is fitted against the side bracket allowing the partially assembled display panel to be received in the inner space through a rectangular opening in one side. A supporting base is attached to the back of the outer case to support the display panel. Such construction is able to reduce the volume of the flat panel display device and simplify the electrical wiring connections between the printed circuit board and the display controller, which no longer need to be wired through the inner case thus cutting down the after-servicing costs and simplifying the assembling procedures.

### BACKGROUND OF THE INVENTION

1. Field of the Invention

The present invention relates to the construction of a flat panel display apparatus that can be assembled with reduced volume and simplified electrical wiring in assembly.

2. Description of Related Arts

Using a flat panel display is more advantageous in many ways as compared to the conventional cathode ray tube (CRT). These light weight flat panel display devices allow end users to save a considerable amount of space on the desktop, and they also do not have electromagnetic radiation (EMR) problems associated with CRT displays since these liquid crystal display panels do not produce oscillating electric and magnetic fields. However, the display module still needs a suitable mechanical structure for holding the display panel at an appropriate viewing angle as well as for support of the display panel and protection of the internal components. Conventional flat panel display devices as shown in FIG. 5 usually include a display panel (90) set in by a side bracket (91), an inner case (80) mounted at the back and secured to the display panel (90) by multiple fasteners (81) at various positions along the perimeter of the inner case (80). A printed circuit board (40) is mounted on one side of the inner case (80) opposite to the display panel (90), and an outer case (70) is mounted over the inner case (80) holding the printed circuit board (40) locked in by multiple fasteners (71). However, the above mentioned mechanical structure of the flat panel display device has several drawbacks:

(1) Increased thickness: Since more room is needed for holding the display components inside the housing, the bulky device is bound to take up more space over the desktop making it more clumsy to transport.

(2) Complicated wiring connections: When assembling the flat panel display device, the outer case has to be dismounted first and several fasteners have to be loosened, before a technician can reach into the printed circuit board and make the necessary electrical connections from the printed circuit board to the terminals on the controller of the display panel, which have to be wired through the inner case.

### SUMMARY OF THE INVENTION

The main object of the present invention is to design a removable frame disposed between the inner case and the display panel, on which a printed circuit board is secured. Such construction allows the overall thickness of the display panel assembly to be reduced considerably by eliminating the space necessary for holding the internal components and wiring, and the electrical wiring in the assembly can also be simplified.

The flat panel display apparatus in accordance with the present invention comprises a display panel, an inner case mounted at the back of the of the display panel having an enclosure for a removable frame, on which a printed circuit board is secured, and an outer case is mounted over the other side of the inner case opposite to the display panel. The outer case joins with the display panel through a rectangular opening in one side receiving the partially assembled display panel in the inner space. The inner case is bound to the display panel by fasteners fixed along the perimeter of the side bracket.

The features and structure of the present invention will be more clearly understood when taken in conjunction with the accompanying figures.

### BRIEF DESCRIPTION OF THE DRAWINGS

FIG. 1 is a perspective view of the present invention;

FIG. 2 is an exploded diagram of the invention;

FIG. 3 is a cross-sectional view of the flat panel display apparatus from the axial plane;

FIG. 4 shows a partially assembled display panel before closing the outer case; and

FIG. 5 is a cross-sectional view of a conventional flat panel display device.

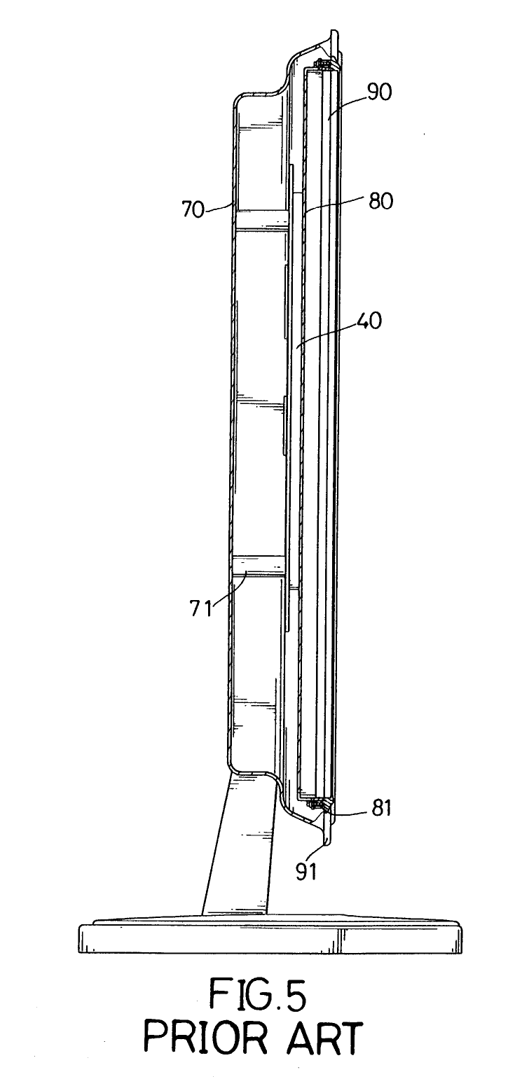

### DETAILED DESCRIPTION OF THE PREFERRED EMBODIMENT

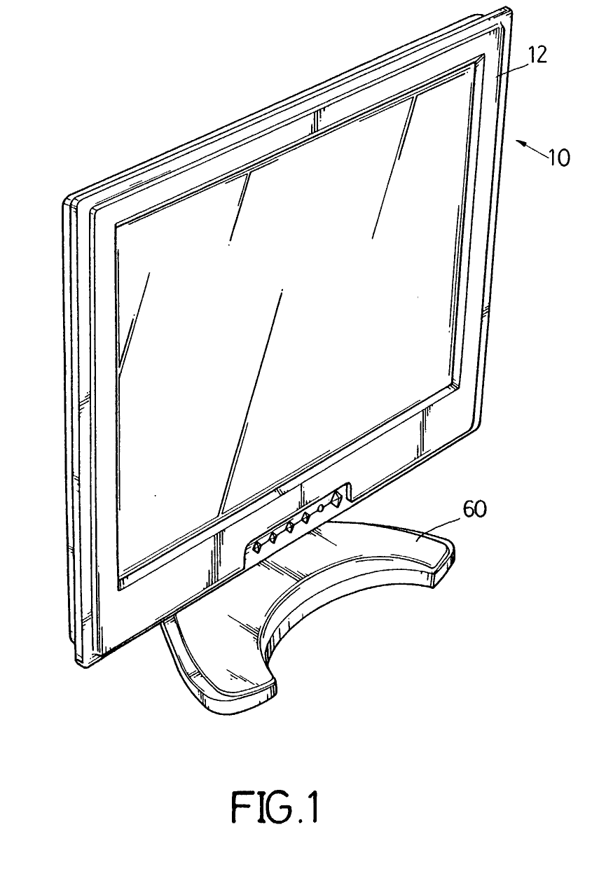

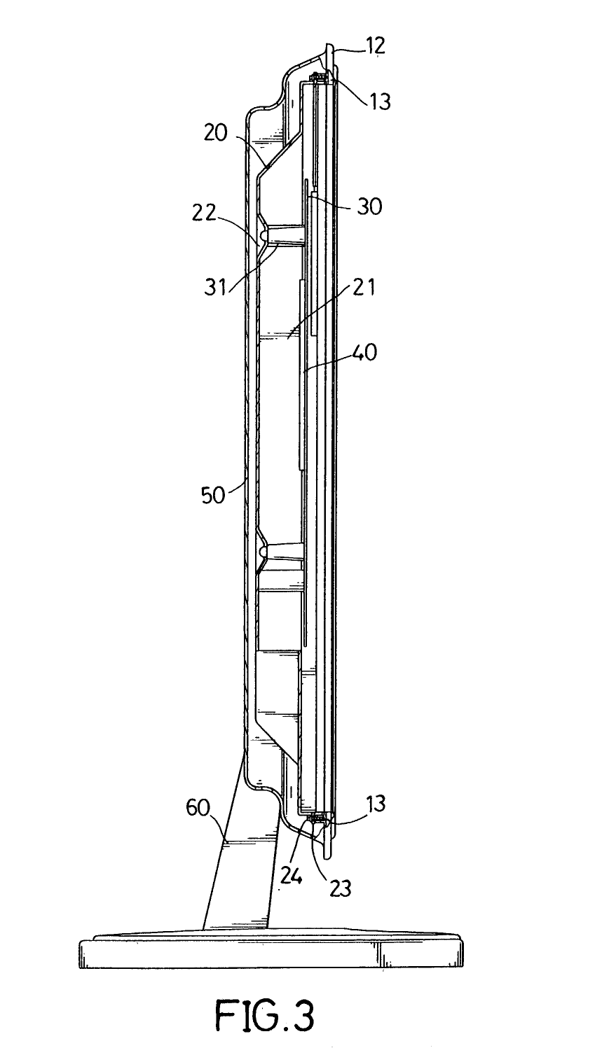

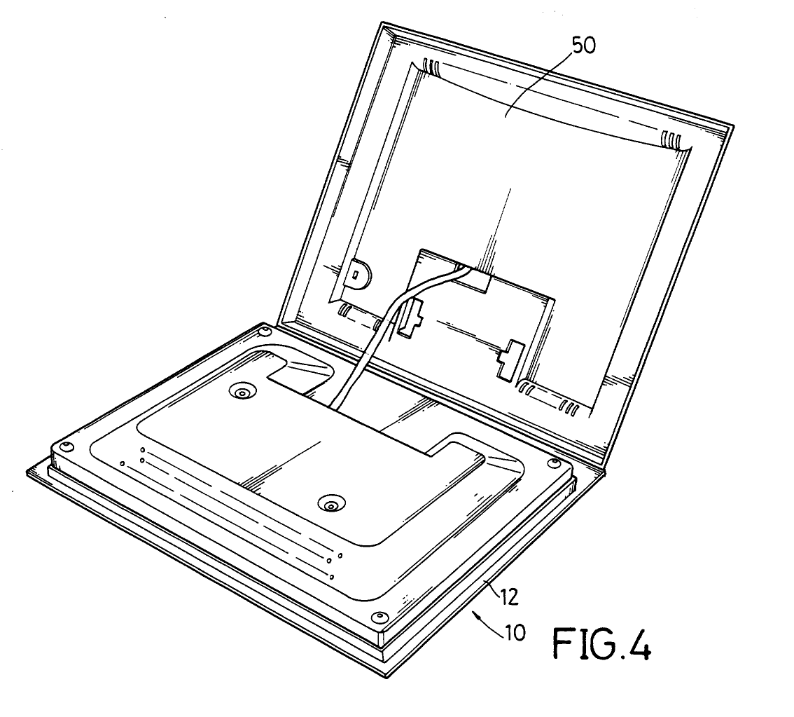

With reference to FIGS. 1, 2, 3 and 4, the flat panel display apparatus mainly comprises a display panel (10), an inner case (20), a removable frame (30), a printed circuit board (40), an outer case (50), and a supporting base (60). The display panel having a display controller (11) on the backside is set in by a side bracket (12), which has multiple sockets fixed along the perimeter on the backside. The inner case (20) is mounted onto the back of the display panel (10) creating an enclosure (21) in between used for holding the removable frame (30). The inner case (20) is bound to the display panel (10) by multiple fasteners (24) which penetrate the corresponding through holes (13) in the inner case (23) and locked against sockets (23) on the side bracket (12). The outer case (50) covers the partially assembled display device.

The removable frame (30) disposed between the display panel (10) and the inner case (20) is secured to the inner case (20) by multiple snap pins (31) which lock against the pin holes (22) of the inner case (20), such that the printed circuit board (30) is secured to the removable frame (30) allowing the electrical wiring to be directly connected to the display controller (11) without having to wire through the inner case (30). The outer case (50) is mounted over the other side of the inner case (20) opposite to the display panel (10), through a rectangular opening in one side receiving the partially assembled display panel (10) in the inner space. A supporting base (60) is attached to the outer case (50) allowing the flat panel display device to be set on a horizontal plane.

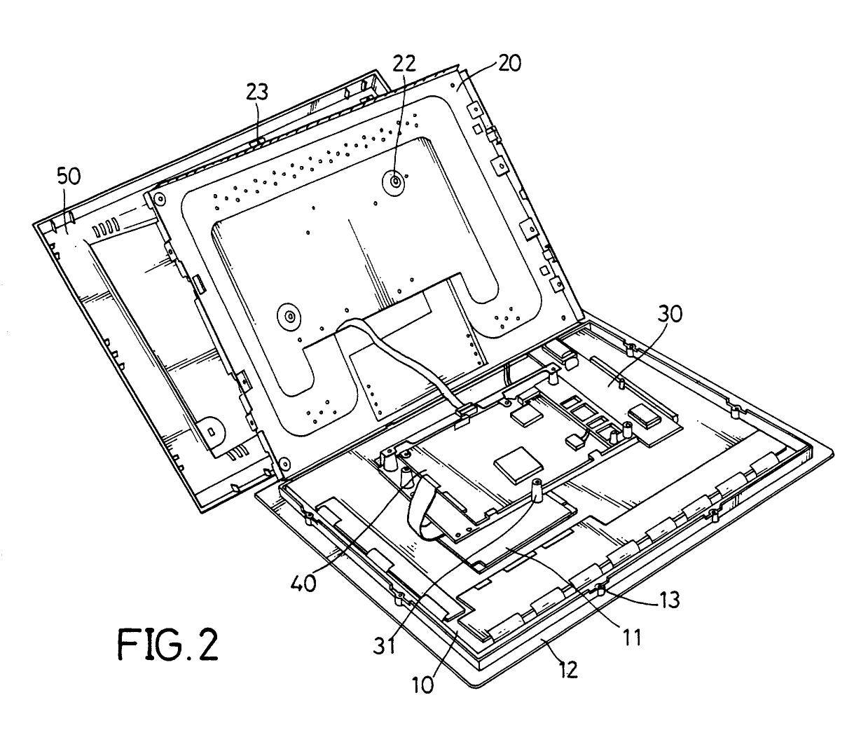

With reference to FIGS. 2, 3 and 4, according to the assembling procedures, the printed circuit board (40) is first secured to the removable frame (30), and then the electrical wiring on the printed circuit board (40) is made to connect to the corresponding terminals on the display controller (11), and then the multiple snap pins (31) of the removable frame (30) are inserted into the pin holes (22) of the inner case (20) for locking the removable frame (30) onto the inner case (20), and then multiple fasteners (24) are placed through the through holes (23) of the inner case (20) and locked onto the sockets (13) of the side bracket (12) to bind the inner case (20) and the display panel (10) together, and then the outer case (50) is fitted against the side bracket (12) of the display panel (10), and finally the supporting base (60) is attached onto the back of the outer case (50) to complete the assembly of a flat panel display apparatus in accordance with the present invention.

According to the assembly procedures for conventional flat panel displays, the printed circuit board (41) is to be installed between the outer case (70) and the inner case (80); but in the present invention, the printed circuit board (40) is installed on the removable frame (30), which is then secured in the enclosed space (21) between the inner case (20) and the display panel (10). The modified construction allows the original space necessary for holding the printed circuit board (41) between the outer case (50) and the inner case (20) to be reduced considerably and the flat panel display device can be assembled with a reduced volume. The present construction also allows the electrical wiring connections from the printed circuit board (40) to be directly connected to the display controller (11) without having to be wired through the inner case (20), thereby simplifying the assembling work and after servicing of the flat panel display device.

The foregoing description of the preferred embodiments of the present invention is intended to be illustrative only and, under no circumstances, should the scope of the present invention be so restricted.

What is claimed is:

1. A flat panel display apparatus comprising:
a display panel;
an inner case being mounted at a back of the display panel;
a removable frame being disposed in between the inner case and the display panel;
a printed circuit board being secured on the removable frame;
an outer case being bound to another side of the inner case opposite to the display panel through a rectangular opening; and
a supporting base being attached to a bottom of the outer case.

2. The flat panel display apparatus as claimed in claim 1, wherein a side bracket is set in around a perimeter of the display panel.
